(19) United States
(12) Patent Application Publication
(10) Pub. No.: US 2003/0128975 A1
(43) Pub. Date: Jul. 10, 2003

(54) Multi-purpose turntable for creation of three dimensional images

(76) Inventor: Barry L. Shevick, Fair Oaks, CA (US)

Correspondence Address: Bradley P. Heisler, Heisler & Associates, Suite 300, 3017 Douglas Blvd., Roseville, CA, 95661, US

(21) Appl. No.: 10/075,991

(22) Filed: Jan. 7, 2002

(51) Int. Cl. G03B 17/00

(52) U.S. Cl. 396/428

(57) ABSTRACT

A turntable is provided for use in the creation of both three dimensional panorama images and three dimensional object images. The turntable includes a base including an upper element and a lower element which rotate relative to each other. A slider block and camera mounting bracket provide a preferred form of a camera attachment fastener so that a camera can be removably but securely fastened to the upper element of the turntable. The camera can then be rotated between sequential pictures so that a panorama image can be created. The camera attachment fastener accommodates adjustment of a position of the camera relative to the upper element of the turntable for optimal positioning of the camera. In a second object mode, an object supporting surface, preferably in the form of a stage, is placed upon the upper element. An object can be placed upon the stage and then the object can be rotated upon the turntable while a camera in a fixed position pointing at the object can take a sequence of pictures which can later be combined together to form a three dimensional object image. The turntable thus functions both to support a camera during the creation of a three dimensional panorama image and to rotatably support an object during the creation of a three dimensional object image.

### FIELD OF THE INVENTION

The following invention relates to turntables used in creating three dimensional images. More particularly, this invention relates to turntables used to support a camera or an object to create three dimensional images such as Quick Time Virtual Reality (QTVR) panorama or object images.

### BACKGROUND OF THE INVENTION

Three dimensional images come in a variety of different styles. One such style of three dimensional image is referred to as a panorama image. With a panorama image, the image includes a 360° view (or less) surrounding a point. Such a panorama image would thus be similar to what a person would see if the person was to stand at the point and turn to look in all directions. Once the panorama image has been created, it can be viewed, such as on a computer monitor, and a control device, such as arrow keys on a keyboard, can be toggled to adjust the portion of the panorama image that the user wishes to view. Hence, with a panorama image the viewer can examine all visible information surrounding the center point of the image, as if the user is standing at the center point.

A panorama image is most commonly created in a two step process. First, a camera is placed at the center point of the panorama image. A sequence of separate pictures are then taken by the camera with each picture differing from other pictures in the sequence in that the camera is rotated to a new position with each picture. In the second step, the pictures are digitally processed so that portions where the pictures overlap are “stitched” together and an entire single panorama image is created. One form of software operable on a personal computer is known as Quick Time Virtual Reality software, provided by the Apple Computer Company of Cupertino, Calif.

An analogous but different type of three dimensional image is an object image. With a three dimensional object image, rather than placing the camera at the center point of the image and rotating the camera between sequential pictures, the object is placed at the center point of the image and the object is sequentially rotated between each picture. The camera is fixed at a location spaced from the object with the camera pointing at the object. Each time the object is rotated a new picture is taken having a slightly different perspective of the object. After the object has been completely rotated (or partially if less than a 360° view is desired) a set of sequential pictures are provided that show all different surfaces of the object.

Again, software such as that operating on a personal computer, can be utilized to “stitch” the adjacent pictures together to form a single three dimensional object image. As with the panorama image, a three dimensional object image can be viewed on a monitor such as a personal computer monitor and a control device, such as arrow keys on a keyboard, can be toggled to allow the viewer to view various different surfaces of the object. One such software package capable of producing such object images is Quick Time Virtual Reality software provided by the Apple Computer Company of Cupertino, Calif.

To facilitate production of three dimensional panorama images, tripod heads have been developed for supporting the camera during the picture taking portion of the panorama image creation process. An overview of such prior art tripod heads is available at the web site www.kaidan.com/products/pano-prods.html, provided by Kaidan Incorporated. In essence, such typical turntables are configured to securely hold a camera at the center point of the panorama image to be created, such as upon a tripod. A system is provided which precisely rotates the camera between sequential pictures taken by the camera.

When three dimensional object images are to be created, turntables are known in the art which can support the object and allow the object to be precisely rotated between sequential pictures. For instance, such turntables are shown and described in detail at www.kaidan.com/products/obj-prods.html provided by Kaidan Incorporated.

While known tripod heads and known turntables provide the basic camera and object rotation for preparation of three dimensional panorama and object images, they only provide such function separately. Accordingly, a need exists for a turntable which can both support a camera for creation of three dimensional panorama images or support an object for creation of three dimensional object images. Both three dimensional panorama images and three dimensional object images can then be easily created with only a single rotating turntable device required for adjustment of the perspective between sequential pictures in creation of the three dimensional images.

### SUMMARY OF THE INVENTION

The turntable of this invention provides the dual purpose of rotatably supporting a camera at a center point of a panorama image being created, or rotatably supporting an object so that the object can be the subject of a three dimensional object image. The turntable includes a base with a top disc or other form of upper element rotatably supported upon a bottom disc or other form of lower element. A camera mounting bracket and slider block provide a preferred form of a camera attachment fastener which allows a camera to be removably attached to the top disc or other upper element of the turntable. The camera is securely attached to the upper element of the turntable so that the camera is very precisely positioned at the center point of the panorama image being created. The camera mounting bracket and slider block preferably allow the camera to be adjusted in position both vertically and horizontally in a side-to-side and a front-to-back fashion, so that the camera can be precisely oriented relative to the upper element of the turntable. Such precise adjustability of camera position relative to the upper element of the turntable facilitates production of the highest quality three dimensional panorama images.

The top disc or other upper element preferably includes stops which control movement of the upper element relative to the bottom disc or other lower element. The upper element is biased to be positioned at one of the stops relative to the lower element. Preferably, the stops are in the form of detents into which the upper element will stop unless sufficient rotational forces are exerted to cause the upper element to further rotate relative to the lower element.

When three dimensional object images are to be created, the camera mounting bracket or other camera attachment fastener is preferably removed and an object supporting surface, such as a stage or pedestal is coupled to the upper element of the turntable. The object supporting surface provides a surface on which an object can be placed with the object located at a pivot point of the turntable. A camera pointing at the object resting upon the object supporting surface then takes a sequence of pictures with the upper element of the turntable rotated relative to the bottom element of the turntable between separate pictures in the sequence, so that a different perspective of the object is provided with each sequentially taken picture. The upper element and lower element of the turntable thus provide for rotation of either the camera when panorama images are to be created, or the object when three dimensional object images are to be created.

### OBJECTS OF THE INVENTION

Accordingly, a primary object of the present invention is to provide a turntable which can support either a camera for creating three dimensional panorama images or an object for creating three dimensional object images.

Another object of the present invention is to provide a turntable which is configured to have a camera attached thereto in an adjustable fashion for precisely locating the camera relative to a pivot point of the turntable so that the highest quality three dimensional panorama images can be created.

Another object of the present invention is to provide a turntable which can have an object supporting surface coupled thereto with the object oriented at a pivot point of the turntable so that the object can be rotated during the creation of three dimensional object images.

Another object of the present invention is to provide a turntable which has an upper element precisely rotatable relative to a lower element with periodic stops between the upper element and lower element to allow a user to easily and precisely rotate the turntable between sequential pictures in the creation of a three dimensional panorama image or a three dimensional object image.

Another object of the present invention is to provide a turntable which is manually rotatable between different stop positions so that a manually powered turntable is provided for supporting a camera during creation of three dimensional panorama images or an object during creation of three dimensional object images.

Another object of the present invention is to provide a turntable which can either be attached to a tripod or rest upon a surface.

Another object of the present invention is to provide a turntable which is easy to use both in supporting a camera or in supporting an object for creation of three dimensional images.

Other further objects of the present invention will become apparent from a careful reading of the included drawing figures, the claims and detailed description of the invention.

### BRIEF DESCRIPTION OF THE DRAWINGS

FIG. 1 is a perspective view of the turntable of this invention shown in a camera supporting mode.

FIG. 2 is a perspective view of the turntable of this invention shown in an object supporting mode.

FIG. 3 is a top plan view of the turntable of this invention in camera supporting mode.

FIG. 4 is a side elevation view of that which is shown in FIG. 3.

FIG. 5 is a front elevation view of that which is shown in FIG. 3 and with the turntable shown in full section to reveal internal details of the turntable.

FIG. 6 is a partially exploded parts view of that which is shown in FIG. 3 with a base portion of the turntable shown assembled and with a slider block and camera mounting bracket forming a preferred form of camera attachment fastener shown exploded off of the assembled base.

FIG. 7 is an exploded parts view of a base portion of the turntable of this invention.

FIG. 8 is a top plan view of the turntable of this invention in an object supporting mode.

FIG. 9 is a side elevation view of that which is shown in FIG. 8.

FIG. 10 is a perspective view of that which is shown in FIG. 8 and with a stage portion of the turntable shown removed from a base portion of the turntable to illustrate how the stage portion is coupled to the base portion.

FIG. 11 is a perspective view of an alternative embodiment of the turntable of this invention in object supporting mode with a pedestal replacing the stage for supporting of the object.

### DESCRIPTION OF THE PREFERRED EMBODIMENT

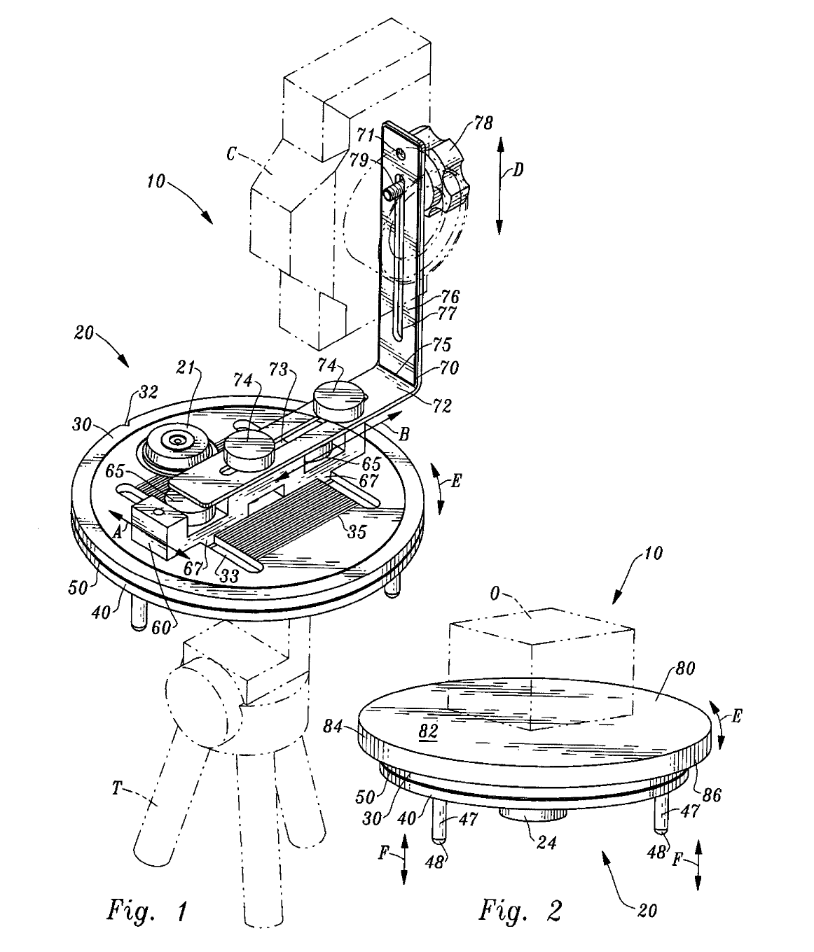

Referring to the drawings, wherein like reference numerals represent like parts throughout the various drawing figures, reference numeral 10 (FIGS. 1 and 2) is directed to a turntable 10 for creation of three dimensional images. In a first mode (FIG. 1) the turntable 10 is configured to support a camera C upon the turntable 10. The camera C can thus be rotated between sequential pictures by the turntable 10 so that the pictures can be later stitched together to form a three dimensional panorama image. In the second object mode (FIG. 2), the turntable 10 supports an object O upon the turntable 10. The object O can thus be rotated between sequential pictures taken by a camera pointing at the object O so that the pictures can be later stitched together to form a three dimensional object image.

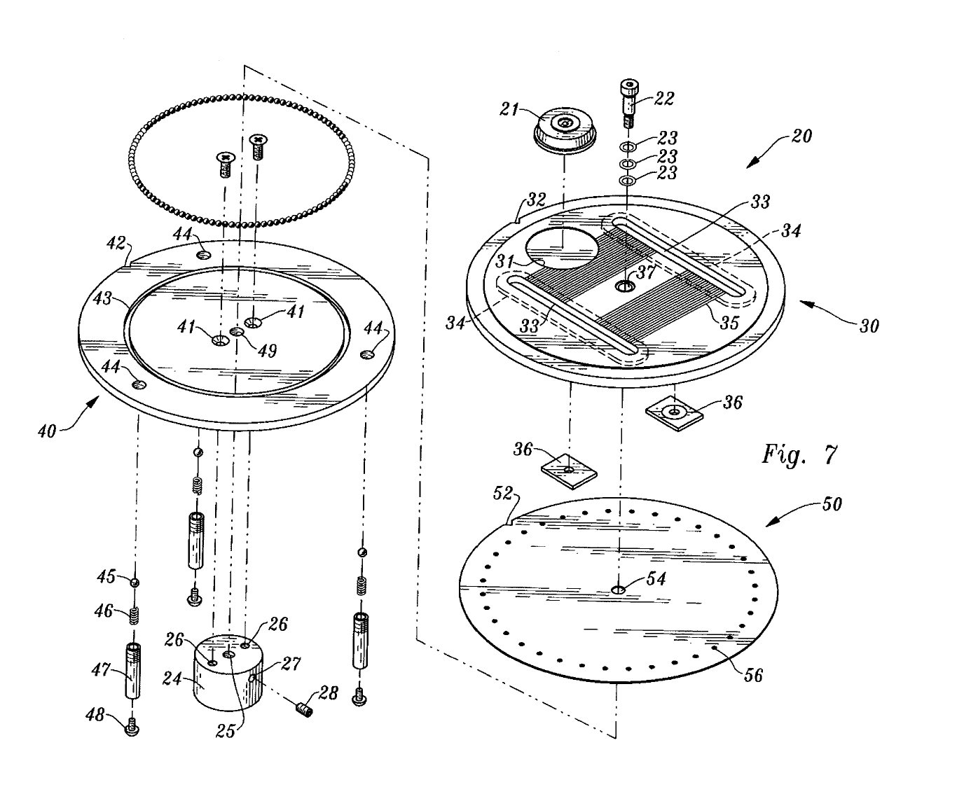

In essence, and with particular reference to FIGS. 1 and 2, basic features of the turntable 10 are described. The turntable 10 includes a base 20 which provides the basic rotational support functionality of the turntable 10 of this invention. The base 20 includes a top disc 30 providing a preferred form of upper element rotatably supported upon a bottom disc 40 providing a preferred form of a lower element. A plate 50 can be interposed between the top disc 30 and bottom disc 40. The plate 50 is preferably secured to the top disc 30 and includes stop holes 56 (FIG. 7) to allow the top disc 30 to be biased toward stopping at regularly spaced intervals relative to the bottom disc 40, between the taking of sequential pictures in creation of the three dimensional images.

When the turntable 10 is in panorama mode, supporting a camera C upon the turntable 10, the slider block 60 is preferably slidably attached to the top disc. The slider block 60 allows the camera C to be adjusted horizontally front-to-back relative to the top disc 30 of the turntable 10. A camera mounting bracket 70 is preferably slidably attached to the slider block 60. The camera mounting bracket 70 is thus horizontally adjustable side-to-side relative to the top disc 30 so that a position of the camera C can be adjusted horizontally side-to-side, relative to the top disc 30 of the turntable 10. The camera mounting bracket 70 additionally includes a vertical arm 76 which can have the camera C attached thereto at various different vertically spaced positions, such that a vertical position of the camera C relative to the top disc 30 can be adjusted.

In object mode, the turntable 10 preferably has the slider block 60 and camera mounting bracket 70 removed and replaced with the stage 80 (FIG. 2). The object O is placed upon the stage 80 and the top disc 30 can be rotated relative to the bottom disc 40 between sequential pictures taken of the object O, so that the turntable 10 in object mode can properly support and position the object O for creation of three dimensional object images with a camera at a fixed position pointing at the object O.

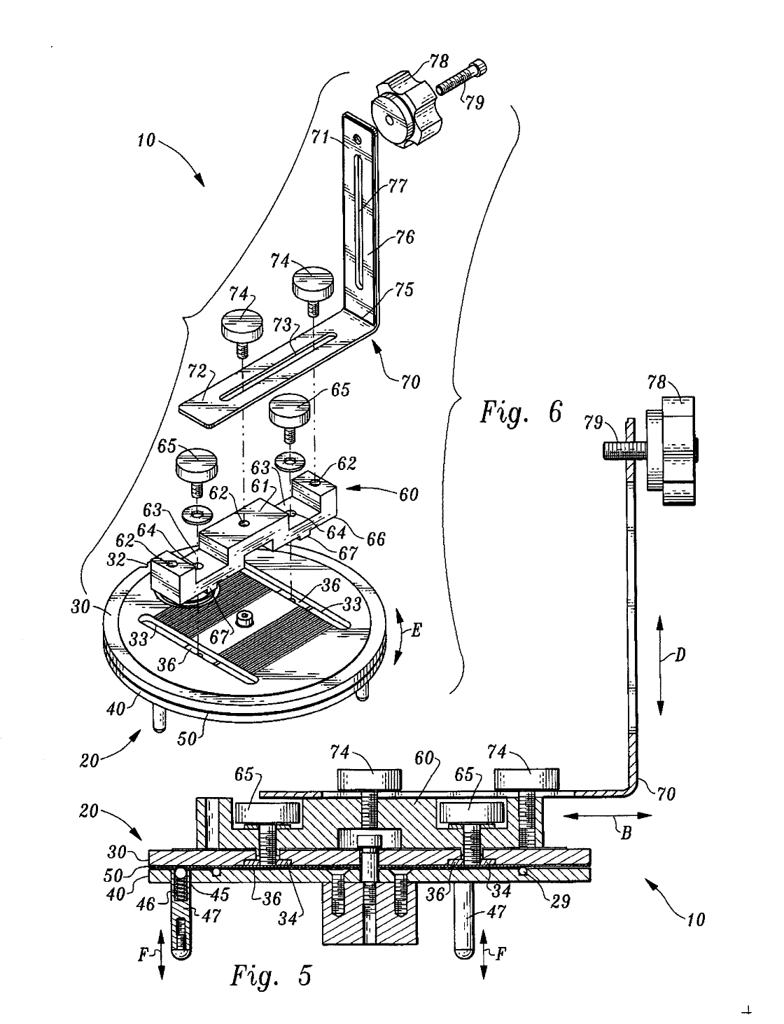

More specifically, and with particular reference to FIGS. 5 and 7, details of the preferred base 20 of the turntable 10 are described. The base 20 provides for basic rotational support function of the turntable 10 in both the camera supporting panorama mode and the object supporting mode of the turntable 10. The base 20 includes three preferably circular discs and associated elements all coupled together to provide the rotational support function of the turntable 10. Specifically, the base 20 includes the top disc 30, bottom disc 40 and plate 50. The base 20 also includes various attachment structures and support structures to allow the discs 30, 40 and plate 50 to be securely supported either upon a tripod T (FIG. 1) or supported upon a surface, such as through the towers 47 (FIGS. 5 and 7).

The top disc 30 provides a preferred form of upper element of the turntable 10. The top disc 30 can also be referred to as a platter. The top disc 30 includes a level recess 31 for mounting of a bubble level 21 there through. A top notch 32 along a perimeter of the top disc 30 identifies rotational displacement of the top disc 30 relative to the bottom disc 40.

Slots 33 pass through the top disc 30. The slots 33 are preferably elongate and linear with rounded ends. Preferably, two slots 33 are provided which are parallel to each other and spaced laterally. The slots 33 accommodate the slider block 60 described in detail below to allow the camera C to be horizontally adjusted in position front-to-back relative to the turntable 10. Each of the slots 33 preferably include a recess 34 on a lower portion of each slot 33 which makes the slots 33 wider in the lower portion of each slot than an upper portion of each slot.

Lines 35 are printed, scribed or otherwise formed on an upper surface of the top disc 30 which extend linearly perpendicular to a long axis of the slots 33. The lines 35 allow a user to easily tell how far the slider block 60 has slid forward or backward within the slots 33. Numbers or letters adjacent the lines 35 can be provided to distinguish the lines 35 from each other.

Nuts 36 are preferably provided which are sized to fit within each of the recesses 34 of the slots 33. The nuts 36 are preferably square or otherwise faceted so that they cannot rotate within the recesses 34 but can slide linearly within the recesses 34 along the slot 33. The nuts 36 have a threaded hole therein which accommodates block knobs 65 used with the slider block 60 to secure the slider block 60 to the top disc 30.

The top disc 30 additionally includes an attachment hole 37 at a central pivot point of the top disc 30. The attachment hole 37 passes entirely through the top disc 30. Preferably, three washers 23 of the bellville washer type hold the top disc 30 to other portions of the base 20 with a pivot screw 22.

The bottom disc 40 is preferably circular in form with two screw holes 41 spaced laterally from a central hole 49 and adjacent the central hole 49 so that the bottom disc 40 can have a tripod block 24 securely attached to the bottom disc 40. The bottom disc 40 is thus fixed to the tripod block 24 and hence to a tripod T so that the bottom disc 40 does not rotate relative to the tripod T or any other underlying support surface.

The bottom disc 40 provides a preferred form of lower element for the turntable 10. The bottom disc 40 can also be referred to as a stationary support upon which the top disc 30, in the form of a platter or upper element, can rotate.

A perimeter of the bottom disc 40 can include a notch 42 thereon to provide a reference with which the top notch 32 of the top disc 30 can be compared so that relative rotation between the top disc 30 and bottom disc 40 can be determined. As an alternative, the bottom disc 40 can have a series of numbers printed or otherwise affixed on the bottom disc 40 at positions which would cause the numbers to be individually viewed through the top notch 32 in the top disc 30 when the top notch 32 is adjacent the numbers in the bottom disc 40. In this way, the precise position of the top disc 30 relative to the bottom disc 40 can be shown.

For instance, if the plate 50 is configured with 36 stop holes 56 so that each stop between the top disc 30 and the bottom disc 40 is spaced ten degrees from adjacent stops. Numbers 1-36 could be provided on the bottom disc 40 with one of these numbers showing through the top notch 32 in the top disc 30, identifying where the top disc 30 is relative to the bottom disc 40.

The bottom disc 40 preferably includes a circular race 43 surrounding the central hole 49. This race 43 accommodates ball bearings 29 which rotatably support the plate 50 and hence the top disc 30 upon the bottom disc 40.

Near a periphery of the bottom disc 40, three threaded detent holes 44 are provided. Each threaded detent hole 44 can receive a tower 47 therein. Alternatively, the towers 47 can be non-threaded and press fit into non-threaded holes 44. The towers 47 are provided with a recess in an upper end of each tower 47 including a detent spring 46 and detent ball 45 (FIG. 5). The detent holes 44 are spaced from the periphery of the bottom disc 40 a distance similar to a distance that the stop holes 56 are spaced from a periphery of the plate 50 so that the detent balls 45 are properly located to snap into the stop holes 56 in the plate 50 when properly rotatably aligned between the plate 50 coupled to the top disc 30 and the bottom disc 40.

While three detent holes 44 and three towers 47 are shown, other numbers of detents and towers 47 could be provided. Preferably, each tower 47 includes a foot 48 threadably coupled to a lower end of each tower 47. The feet 48 can thus be rotated to slightly adjust a height of each tower 47. When the base 20 is to rest upon a surface, the feet 48 can be rotated so that the base 20 can be precisely leveled upon a surface that is not entirely horizontal.

The plate 50 is preferably formed from a harder material than the top disc 30 and bottom disc 40, with that material of the plate 50 preferably being a steel such as stainless steel, while the top disc 30 and bottom disc 40 are formed from a lighter material, preferably aluminum. The plate 50 can thus exhibit long life and secure a precise position for the top disc 30 relative to the bottom disc 40 at the various stops, even after prolonged use.

The plate 50 includes a middle notch 52 aligned with the bottom notch 42 so that alignment of the top disc 30 relative to the bottom disc 40 can be visualized. A central hole 54 in the plate 50 aligns with the central hole 49 of the bottom disc 40 and the attachment hole 37 of the top disc 30 for coupling of the discs 30, 40 and plate 50 together with the pivot screw 22. The bubble level 21 is preferably attached, with a suitable adhesive, to the plate 50 and extends up through the level recess 31 in the top disc 30 so that a bubble in the bubble level 21 can be viewed for proper leveling of the base 20. An appropriate adhesive, or other fastener, is provided to secure the plate 50 to the top disc 30.

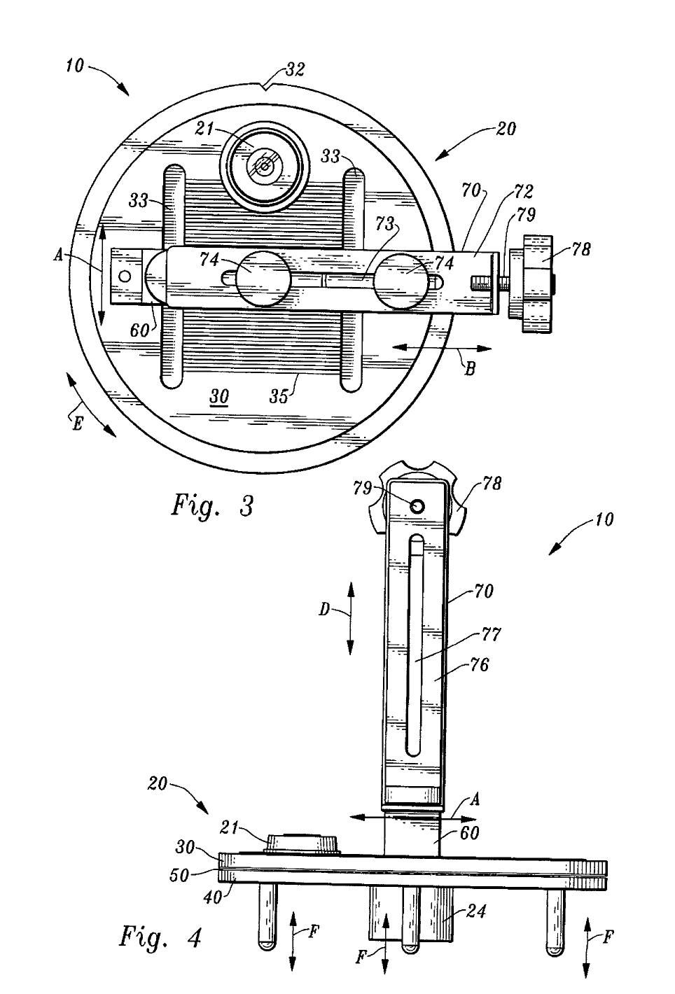

The tripod block 24 of the base 20 includes a pivot hole 25 which receives the pivot screw 22 therein. Lateral holes 26 adjacent the pivot hole 25 receives screws passing through the screw holes 41 adjacent the central hole 49 in the bottom disc 40 so that the tripod block 24 can be securely attached to the bottom disc 40. A retainer hole 27 passes through a side of the tripod block 24 and intersects with the pivot hole 25. A retainer screw 28 can be threaded into the retainer hole 27 to abut against the pivot screw 22 within the pivot hole 25 to securely hold the pivot screw 22 within the tripod block 24. The pivot hole 25 passes entirely through the tripod block 24 and so has a lower end which is threaded to receive a threaded stud of a tripod so that the tripod block 24 can be secured to the top of a tripod. In this way, the entire base 20 can be secured to a tripod with the bottom disc 40 held fixed relative to the tripod and with the top disc 30 and plate 50 free to rotate, about arrow E of FIGS. 1-3 and 6, relative to the bottom disc 40 and tripod T (FIG. 1).

With particular reference to FIGS. 1 and 3-6, details of the preferred assembly to provide a means to support the camera on the base 20 of the turntable 10 are described. Preferably, the camera supporting means is in the form of a camera attachment fastener including the slider block 60 and the camera mounting bracket 70. The slider block 60 provides for attachment to the top disc 30 or upper element of the turntable 10 and accommodates horizontal sliding of the camera C, along arrow A of FIG. 1. The camera mounting bracket 70 provides for horizontal side-to-side adjustment of a position of the camera C relative to the top disc 30 or other upper element, along arrow B of FIGS. 1, 3 and 5. Camera mounting bracket 70 also provides for vertical position adjustment of the camera C relative to the top disc 30 or other upper element of the turntable 10, along arrow D of FIGS. 1, 4 and 5.

The slider block 60 is preferably a rigid structure formed from a unitary mass of material. The slider block 60 includes an upper surface 61 with at least three upper holes 62 extending vertically down through the upper surface 61. At least two troughs 63 are cut down through the upper surface 61 of the slider block 60. Trough holes 64 extend down from the troughs 63 through to a lower surface 66 of the slider block 60. Preferably, the trough holes 64 are not threaded and block knobs 65 with threaded studs extending therefrom pass through the trough holes 64 and then thread into the nuts 36 within the slots 33 in the top disc 30.

The trough holes 64 extend out through tongues 67 which extend down from the lower surface 66 of the slider block 60. The tongues 67 have a width similar to a width of the slots 33 in the top disc 30. The tongues 67 thus reside within the slots 33 and the block knobs 65 extend down through the trough holes 64 and through the tongues 67 to thread into the nuts 36 residing in the recesses 34 beneath the slots 33.

When the block knobs 65 are thoroughly tightened, the nuts 36 secure the slider block 60 in position. When the block knobs 65 are loosened somewhat, the slider block 60 can slide, along arrow A of FIGS. 1, 3 and 4, to adjust a horizontal front-to-back position of the slider block 60 and hence the camera C (FIG. 1). The slider block 60 thus provides one form of a means to adjust a horizontal position of the camera C relative to the top disc 30 or other upper element of the turntable 10. The lower surface 66 preferably also includes a cut out area near a center of the lower surface 66 to allow the slider block 60 to easily pass over the head of the pivot screw 22 holding the top disc 30 to other portions of the base 20.

The camera mounting bracket 70 preferably provides the remainder of the means to support the camera with the top disc 30 or other upper element of the turntable 10. The camera mounting bracket 70 is configured as a rigid structure including a horizontal arm 72 perpendicular with a vertical arm 76 joined to the horizontal arm 72 at a corner 75. A horizontal slot 73 extends longitudinally within the horizontal arm 72. A pair of bracket knobs 74 preferably pass through the horizontal slot 73 and are configured to have threads at the bracket knobs 74 mate with threads in the upper holes 62 formed in the upper surface 61 of the slider block 60. Hence, when the bracket knobs 74 are tight, a horizontal side-to-side position of the camera C, along arrow B of FIGS. 1, 3 and 5, can be secured.

When the bracket knobs 74 are loosened, the camera mounting bracket 70 can be moved horizontally side-to-side along arrow B. Hence, the camera mounting bracket 70 allows the camera C (FIG. 1) to be precisely oriented with an image center of the camera C aligned with a center point of a three dimensional panorama image to be created.

The camera mounting bracket 70 can be reversed by utilizing different upper holes 62 in the slider block 60. Similarly, the camera mounting bracket 70 can be moved over to any two upper holes 62, either with or without reversing the position of the vertical arm 76 relative to the horizontal arm 72. The horizontal slot 73 is sufficiently long to allow two upper holes 72 to be aligned with the horizontal slot 73 and two bracket knobs 74 to extend through the horizontal slot 73 at the same time.

The vertical arm 76 includes a vertical slot 77 extending longitudinally therethrough. The vertical slot 77 accommodates the camera knob 78 passing through the vertical slot 77 and into a threaded hole in the base of the camera C (FIG. 1). The camera knob 78 preferably is not affixed to the camera bolt 79, but rather the camera knob 78 is provided with threads to threadably be supported upon the camera bolt 79. In this way, the camera bolt 79 can be rotated by itself until it totally fills the threaded hole in the camera C. The camera knob 78 can then be rotated until a lower surface of the camera C comes into engagement with the vertical arm 76 to secure the camera C to the vertical arm 76 at the desired vertical position, by adjustment along arrow D of FIGS. 1, 4 and 5. A surface of the vertical arm 76 adjacent the camera has preferably a high friction rubberized feel, to help securely but gently hold the camera C still relative to the top disc 30. A knob storage hole 71 is preferably provided upon the vertical arm 76 for storage of the camera knob 78 and camera bolt 79 when not in use to hold the camera C adjacent the camera mounting bracket 70.

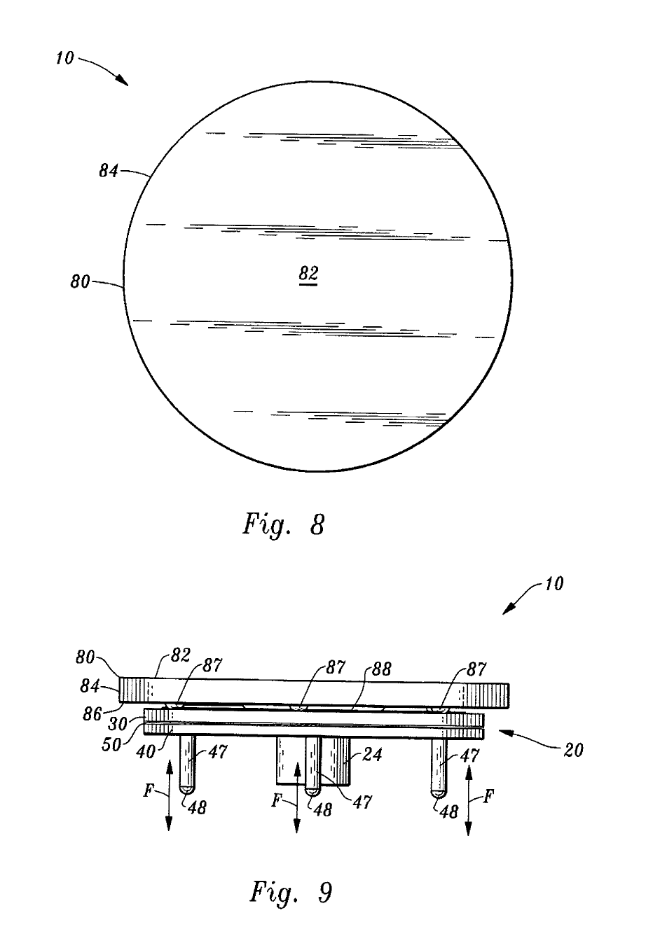

With particular reference to FIGS. 2 and 8-10, details of the turntable 10 in its object supporting mode are described. To utilize the turntable 10 in the object mode, the turntable 10 is fitted with a means to support an object, preferably in the form of an object supporting surface such as the stage 80 (FIGS. 2 and 8-10). Of course any surface capable of supporting an object O thereon could similarly be utilized. Typically, the turntable 10 is placed upon a surface, such as a table top, through use of the towers 47 when the turntable 10 is to be used in object mode. However, the turntable 10 can be supported through the tripod block 24 to a tripod T (FIG. 1) if desired. When the turntable 10 is resting upon a substantially horizontal surface, the feet 48 at tips of the towers 47 can be rotated to adjust their height, along arrow F of FIGS. 2, 9 and 10, so that the turntable 10 is appropriately oriented for use.

Preferably, the slider block 60 and camera mounting bracket 70 are removed from the base 20 and the stage 80 is placed on the top disc 30 or other upper element of the turntable 10. The stage 80 includes a top surface 82 and perimeter 84 which are preferably of a common color and without variations in color or texture. Most preferably, the top surface 82 and perimeter 84 are provided with a color which is a standard color utilized in photo editing so that the stage 80 can be digitally removed from images in a straightforward fashion.

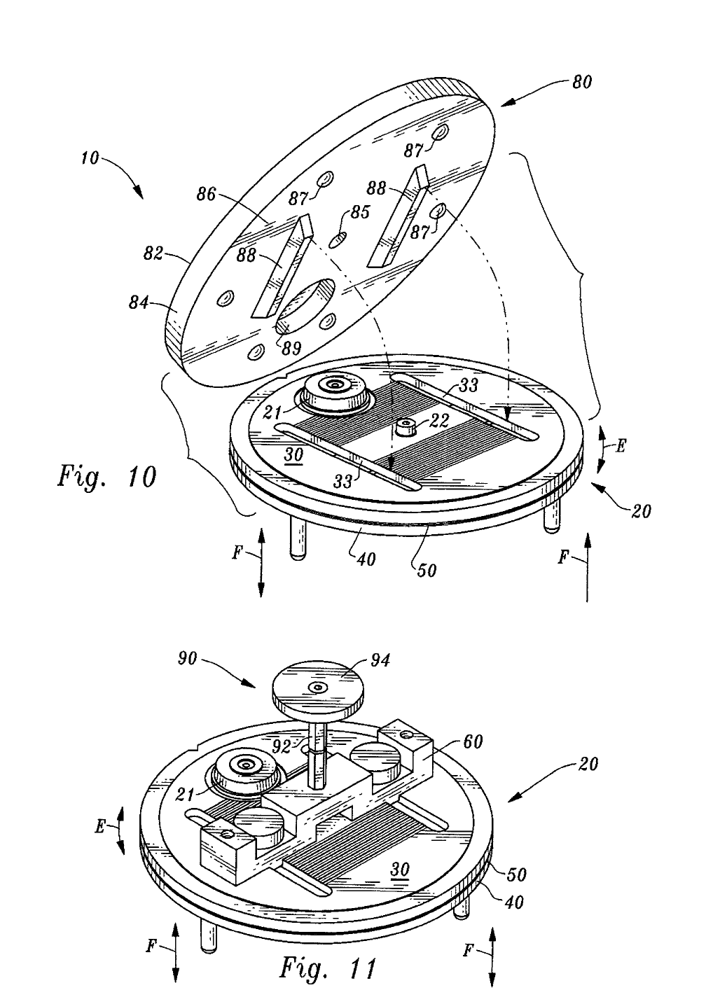

The stage 80 includes a bottom surface 86 (FIG. 10) which includes two ribs 88 thereon. The ribs 88 are sized to fit snugly within the slots 33 in the top disc 30. In this way, the stage 80 is prevented from rotating or translating horizontally relative to the top disc 30. Preferably, the bottom surface 86 additionally includes a pivot relief 85 to rest over the head of the pivot screw 22, humps 87 to provide support for the stage 80 upon the top disc 30 and a level relief 89 to keep the bubble level 21 from interfering with horizontal placement of the stage 80 upon the top disc 30.

The top disc 30 and stage 80 can then be rotated relative to the bottom disc 40 so that the object O (FIG. 2) can be effectively rotated, about arrow E, between separate photos in the formation of the object image with a stationary camera pointing at the object O.

For smaller objects O and circumstances where it is desirable to have a backdrop for the object O which remains stationary, an alternative embodiment of the stage 80 is provided in the form of the pedestal 90 (FIG. 11). With the use of the pedestal 90, the slider block 60 is first replaced upon the top disc 30. The pedestal 90 is then attached to the slider block 60 with the slider block 60 provided passing over the pivot screw 22 of the base 20. The pedestal 90 includes a post 92 which has threads at a lower end which thread into the middle upper hole 62 in the slider block 60. An upper end of the post 92 is fitted with a platform 94 upon which an object can be placed.

A sheet of backdrop material, preferably of an appropriately easy to digitally remove color, can be oriented with a hole in the backdrop passed through by the post 92. The backdrop can be angled diagonally to drape over and hide features of the turntable 10 and additionally extend up behind the object O. As the top disc 30 and pedestal 90 are rotated, about arrow E of FIG. 11, the backdrop is kept in substantially constant position hiding background features. In this way, an easily editable sequence of pictures is provided so that the separate pictures can be easily stitched together to form the three dimensional object image utilizing appropriate software as discussed above.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified. When elements are described as being coupled together, the term coupled should be given its broadest meaning to identify any form of connection or joining of the elements, either directly together or through intervening elements and with the connection between the coupled elements being either a rigid connection or a flexible connection. When an element is described as an object supporting surface, such a surface is intended to be limited to surfaces which are in some way adapted or optimized for supporting an object O thereon for the creation of three dimensional object images, rather than any structure which is in any way capable of having an object supported thereon.

What is claimed is:

1- A turntable for use in creating three-dimensional images of both a panorama type and an object type, comprising in combination:
a lower element;
an upper element rotatably supported upon said lower element;
means to support a camera with said upper element when panorama type images are to be created; and
means to support an object with said upper element when object type images are to be created.

2- The turntable of claim 1 wherein said camera supporting means includes at least one fastener for coupling the camera to said upper element.

3- The turntable of claim 2 wherein said camera supporting means includes means to adjust a position of the camera relative to said upper element.

4- The turntable of claim 3 wherein said upper element is a top disc, said lower element is a bottom disc and a rotational bearing is interposed between said top disc and said bottom disc.

5- The turntable of claim 4 wherein said top disc includes at least one linear elongate slot therein, said camera supporting means at least partially including a block having a tongue on a lower surface of said block, said tongue having a width similar to a width of said slot, such that said tongue can slide in said block.

6- The turntable of claim 5 wherein said camera supporting means includes a bracket coupled to an upper surface of said block, said bracket including a horizontal arm and a vertical arm, said horizontal arm fastened to said block, said vertical arm adapted to have the camera coupled thereto.

7- The turntable of claim 6 wherein all connections between said horizontal arm and said block are horizontally adjustable to adjust a position of said bracket relative to said block and all connections between said vertical arm and the camera are vertically adjustable to adjust a vertical position of the camera relative to said bracket.

8- The turntable of claim 7 wherein said horizontal arm includes an elongate horizontal slot, said horizontal slot having at least two rotatable knobs passing therethrough with threads engagable within said upper surface of said block, such that said knobs adjustably attach said horizontal arm of said bracket to said upper surface of said block; and
wherein said vertical arm includes an elongate vertical slot extending vertically through said vertical arm, said vertical slot having at least one knob passing therethrough with a threaded shaft attachable to the camera, said knob in said vertical slot adjustably positionable vertically to adjust a vertical position of the camera relative to said bracket.

9- The turntable of claim 1 wherein said object supporting means includes a stage coupled to said upper element, said stage adapted to support an object thereon.

10- The turntable of claim 9 wherein said upper element includes at least one slot therein, said stage including at least one rib sized to reside within said slot in said upper element such that relative motion between said stage and said upper element is substantially avoided.

11- The turntable of claim 10 wherein said stage is larger than said upper element.

12- The turntable of claim 1 wherein a plurality of stops are provided to influence rotational displacement of said upper element relative to said lower element, said stops rotationally spaced from adjacent stops.

13- The turntable of claim 12 wherein at least three of said stops are spaced from adjacent stops by a common distance.

14- The turntable of claim 12 wherein said stops include detents biasing said upper element and said lower element to be positioned rotationally relative to each other at one of said stops.

15- The turntable of claim 12 wherein said upper element includes a notch therein and said lower element includes a notch therein, a distance between notches in said upper element and said lower element visibly showing an amount of angular displacement said upper element is experiencing relative to said lower element.

16- The turntable of claim 12 wherein said upper element includes a notch therein, said notch revealing numbers therein, said numbers indicating which stop said upper element resides at relative to said lower element.

17- A method for making three dimensional images of either a panorama type or an object type with a common turntable including an upper element rotatably supported upon a lower element, the steps of the method including:
supporting a camera with the upper element of the turntable when panorama images are to be made; and
supporting an object with the upper element of the turntable when object images are to be made.

18- The method of claim 17 wherein said camera supporting step includes the step of coupling the camera to the upper element.

19- The method of claim 18 wherein said camera supporting step includes the step of removably securing the camera to the upper element in a manner precluding relative motion between the camera and the upper element.

20- The method of claim 19 wherein said camera supporting step includes the step of adjusting a position of the camera relative to the upper element while the camera remains coupled to the upper element.

21- The method of claim 20 wherein said adjusting step includes vertically adjusting a position of the camera relative to the upper element, horizontally adjusting a position of the camera relative to the upper element in a side-to-side fashion and horizontally adjusting a position of the camera relative to the upper element in a front-to-back fashion.

22- The method of claim 21 wherein said camera supporting step includes the step of providing a block slidably attached to the upper element, the block including at least one tongue on a lower surface having a width similar to at least one slot in the upper element, the slot extending in a front-to-back direction horizontally, and a bracket having a horizontal arm and a vertical arm, the horizontal arm horizontally slidably attached to the block and the vertical arm vertically slidably attached to the camera, such that the horizontal arm of the bracket accommodates side-to-side adjustment of the camera relative to the upper element and the vertical arm accommodates vertical adjustment of the camera relative to the upper element.

23- The method of claim 22 including the further step of converting the turntable from a camera supporting mode to an object supporting mode by removing at least the bracket from the upper element and placing a stage upon the upper element, the stage having an area sufficient to cover the upper element.

24- The method of claim 17 including the further steps of:
taking a picture;
rotating the upper element relative to the lower element to rotate either the camera or object supported upon the upper element;
repeating said picture taking step;
repeating said rotating step; and
combining pictures taken in said multiple picture taking steps into a single image of a panorama type or object type.

25- A turntable for supporting either a camera for creating three dimensional panorama images or an object for creating three dimensional object images, comprising in combination:
a stationary support;
a platter rotatably connected to said stationary support;
a camera attachment fastener coupleable to said platter; and
an object supporting surface coupleable to said platter.

26- The turntable of claim 25 wherein said camera attachment fastener is removably coupleable to said platter.

27- The turntable of claim 26 wherein said object supporting surface is removably coupleable to said platter.

28- The turntable of claim 27 wherein when said object supporting surface is coupled to said platter said camera attachment fastener is not coupled to said platter and when said camera attachment fastener is coupled to said platter said object supporting surface is not coupled to said platter.

29- The turntable of claim 27 wherein said object supporting surface includes a stage, said stage including a top surface upon which the object can rest.

30- The turntable of claim 27 wherein said object supporting surface is a pedestal, said pedestal including a post attachable at a lower end to said platter at a pivot point of said turntable and a platform at an upper end of said post, said platform adapted to support an object thereon.

31- The turntable of claim 26 wherein said camera attachment fastener is adapted to securely attach the camera to the platter.

32- The turntable of claim 31 wherein said camera attachment fastener is adjustable in three mutually perpendicular directions such that a position of the camera relative to the platter can be adjusted.

33- The turntable of claim 32 wherein said platter includes at least one linear elongate slot therein, said camera supporting means at least partially including a block having a tongue on a lower surface of said block, said tongue having a width similar to a width of said slot, such that said tongue can slide in said block.

34- The turntable of claim 33 wherein said camera attachment fastener includes a bracket coupled to an upper surface of said block, said bracket including a horizontal arm and a vertical arm, said horizontal arm fastened to said block, said vertical arm adapted to have the camera coupled thereto.
